(19) United States
(12) Patent Application Publication
(10) Pub. No.: US 2023/0195928 A1
(43) Pub. Date: Jun. 22, 2023

(54) DETECTION AND PROTECTION OF PERSONAL DATA IN AUDIO/VIDEO CALLS

(71) Applicant: PayPal, Inc., San Jose, CA (US)

(72) Inventor: Vaidehi Sridhar, Vellore (IN)

(21) Appl. No.: 17/814,313

(22) Filed: Jul. 22, 2022

(30) Foreign Application Priority Data
Dec. 16, 2021 (IN) 202111058830

(51) Int. Cl. G06F 21/62; G06F 21/60; G10L 15/26

(52) U.S. Cl. CPC G06F 21/6245; G06F 21/602; G10L 15/26

(57) ABSTRACT

An architecture and techniques for detecting and protecting personally identifiable information (PII) is presented. The disclosed techniques can detect and protect PII that exists in unstructured data stores and/or in audio/visual (A/V) files such as audio files or video files that are stored by call center entities for quality or training purposes, which, unlike most structured data formats, may not be protected in accordance with privacy laws or regulations.

### CROSS-REFERENCE TO RELATED APPLICATION

This application claims priority to India Provisional Patent Application No. 202111058830, filed on Dec. 16, 2021, and entitled “DETECTION AND PROTECTION OF PERSONAL INFORMATION”, the entirety of which application is hereby incorporated by reference herein.

### TECHNICAL FIELD

This disclosure relates generally to detection and protection of personal information in audio/video (AV) files such as those stored by companies, call centers or the like.

### BACKGROUND

When a company or third-party call center communicates with a customer or potential customer, the interaction is often recorded and saved to a data store. Subsequently, the interaction can be reviewed for training purposes or evaluation of associated employee performance. Most are familiar with examples of an indication similar to “this call is being recorded for quality and training purposes”. Hence, companies have an interest in storing this type and similar types of information, which may be retained up to about seven years.

It is very common that, during the recorded interaction, personal information (e.g., name, address, account number, social security number, mother's maiden name, and so forth), will be requested for identity verification or otherwise divulged. Furthermore, even certain biometric information (e.g., voiceprint of a name or certain phrase or face for video media) can be captured and recorded.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

In accordance with a non-limiting, example implementation, a system can receive text data representing a transcription of recorded speech encoded in a file. The system can determine the text data comprises personally identifiable information (PII). The system can determine a time map that indicates a time segment of the file that corresponds to a presentation of the personally identifiable information. The system can encrypt a portion of the file corresponding to the time segment.

In some embodiments, elements described in connection with the systems or apparatuses above can be embodied in different forms such as a computer-implemented method, a computer program product comprising a computer-readable medium, or another suitable form.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a schematic block diagram is presented of an example system 100 that can facilitate identification and protection of PII in accordance with certain embodiments of this disclosure;

FIG. 2 depicts a schematic block diagram illustrating additional aspects or elements of system 100 in connection with identification and protection of PII in accordance with certain embodiments of this disclosure;

FIG. 3 depicts an example schematic flow diagram illustrating example techniques of identification and protection of PII in accordance with certain embodiments of this disclosure;

FIG. 4 depicts an example schematic flow diagram illustrating a data store analyzer applied to existing data in accordance with certain embodiments of this disclosure;

FIG. 5 depicts an example schematic flow diagram illustrating an audio analyzer applied on-the-fly to recorded interactions in accordance with certain embodiments of this disclosure;

FIG. 6 depicts an example schematic flow diagram illustrating additional aspects or elements relating to scanning and interfacing data stores in accordance with certain embodiments of this disclosure;

FIG. 7 illustrates an example schematic flow diagram illustrating additional aspects or elements in connection with extracting text data from A/V files in accordance with certain embodiments of this disclosure;

FIG. 8 depicts an example schematic flow diagram illustrating an example PII scanner and audio text plot in accordance with certain embodiments of this disclosure;

FIG. 9 depicts an example schematic flow diagram illustrating additional aspects or elements in connection with masking the PII in accordance with certain embodiments of this disclosure;

FIG. 10 depicts an example schematic flow diagram illustrating additional aspects or elements in connection with encrypting information in accordance with certain embodiments of this disclosure;

FIG. 11 depicts a flow diagram of an example method for facilitating identification and protection of PII in accordance with certain embodiments of this disclosure;

FIG. 12 depicts a flow diagram of an example method for providing additional aspect or elements in connection with facilitating identification and protection of PII in accordance with certain embodiments of this disclosure;

FIG. 13 is a schematic block diagram illustrating a suitable operating environment in accordance with certain embodiments of this disclosure;

FIG. 14 is a schematic block diagram of a sample computer communication environment in accordance with certain embodiments of this disclosure;

FIG. 15 illustrates an example computing architecture for facilitating one or more blockchain based transactions in accordance with certain embodiments of this disclosure;

FIG. 16 illustrates an example blockchain network in accordance with certain embodiments of this disclosure; and

FIG. 17 illustrates an example blockchain in accordance with certain embodiments of this disclosure.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure might be practiced without these specific details, or with other methods, components, materials, etc. In other instances, well-known structures and devices are shown in block diagram form to facilitate describing one or more aspects.

As noted in the Background section, when a company or third-party call center communicates with a customer or potential customer, the interaction is often recorded and saved to a data store. Most are familiar with examples of an indication similar to “this call is being recorded for quality and training purposes”. Hence, companies have an interest in storing this type and similar types of information, which may be retained up to about seven years.

However, certain issues can arise. It is very common that, during the recorded interaction, personal information (e.g., name, address, account number, social security number, mother's maiden name, and so forth), will be requested for identity verification or otherwise divulged. Furthermore, even certain biometric information (e.g., voiceprint of a name or certain phrase or face for video media) can be captured and recorded. Because these audio/visual (AV) files are stored, for instance for training or evaluation, there is a risk that such personal or otherwise sensitive information can be illicitly acquired or otherwise obtained or used without authorization. For example, these files might be exposed to the efforts of hackers or illegitimately accessed by employees, whereby the personal information revealed in those files might also be exposed.

Privacy laws like General Data Protection Regulation (GDPR), California Consumer Privacy Act (CCPA), General Data Protection Law (LGPD) and others all focus on the major privacy requirement of protecting customer personal information in any format. In practice, however, there are two different ways in which personal data, hereinafter referred to as personally identifiable information (PII), is collected and stored.

The first is structured data, which is textual information (e.g., name, email address, ID indicators, date of birth, and so on) a customer can submit during account creation and/or know-your-customer (KYC) onboarding. This information is easily structured and typically stored in a relational database. As such, protecting this information, as demanded by current and forthcoming privacy laws is not especially difficult.

The second way of collecting and storing PII is unstructured data, an example of which is the previously described call center interaction in which PII is revealed by the customer and stored to company devices, generally for training and evaluation purposes. Unlike structured data, unstructured data (e.g., National ID document, KYC interactions, voice calls recorded by customer care, video calls, email communications and so forth) is not generally stored to a relational database and is typically collected in raw format. Hence, many companies retain both structured and unstructured data, and either one can contain PII.

However, privacy laws and other related regulation tend not to distinguish between the technological constraints that define structured data versus unstructured data. Rather, all PII tends to be treated the same way by policy makers, demanding the same protection for PII in structured storage as PII in unstructured storage. Yet, techniques utilized to secure data in unstructured storage formats cannot be used for unstructured storage formats. Thus, companies face significant challenges in meeting privacy law requirements in the existence of unstructured data.

In the industry, many observers believe that one of the major issues with unstructured data is the difficulty of locating PII within their data stores. Furthermore, even if such data is identified, there is another challenge of how to protect that information in accordance with the privacy laws. As noted, for structured data, data parsers can use content- and context-based text identifiers applied on a table of column names or text stored in a relational database in order to readily identify PII. Unfortunately, the same methods cannot be applied to unstructured data, as unstructured data are not stored in a structured or organized format. Of all the many types of unstructured data, audio and video calls represent the most challenging to handle.

Subject matter disclosed herein relates to identifying and protecting PII that is retained in unstructured data formats (or even structured data formats such as binary large object (BLOB) type columns or the like), including PII stored in audio or video formats, such as call center interactions that are recorded and retained for quality or training purposes. Application of the techniques detailed herein can allow companies to securely store such unstructured data in a manner that protects customer information and satisfies privacy law requirements.

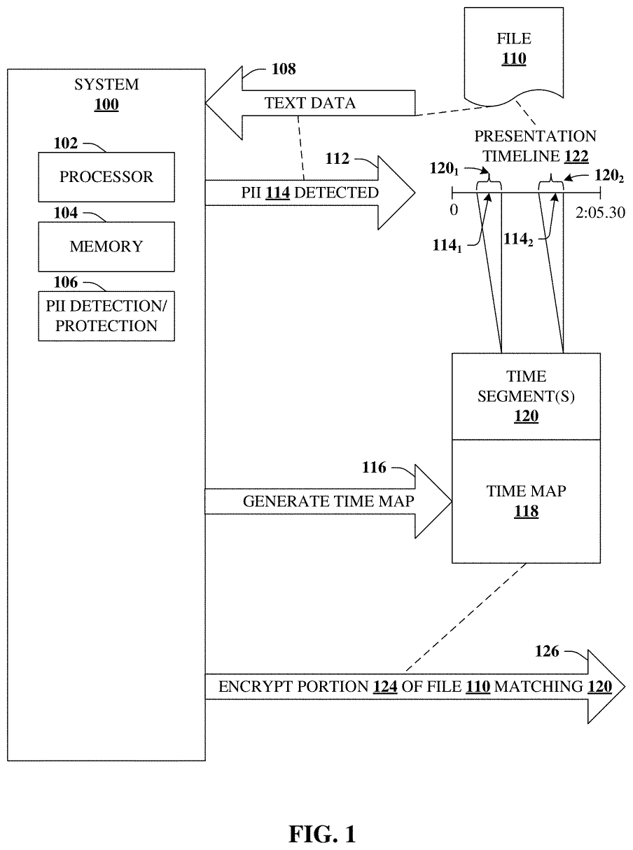

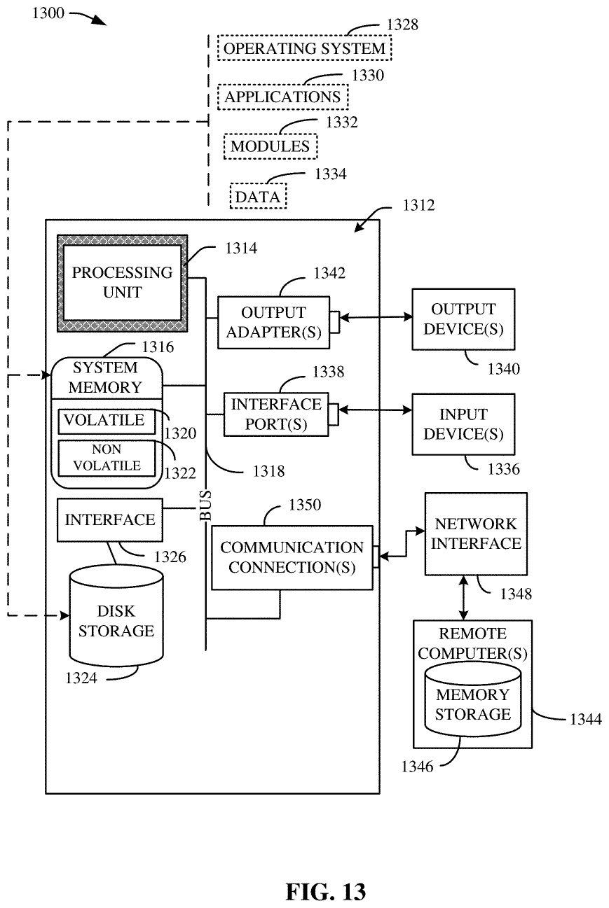

Referring initially to FIG. 1, a schematic block diagram is presented of an example system 100 that can facilitate identification and protection of PII in accordance with certain embodiments of this disclosure. For example, system 100 can locate and securely protect PII in AV files that are collected and stored by an entity. System 100 can comprise a processor 102 that can be specifically configured to provide PII detection or protection 106. System 100 can also comprise memory 104 that stores executable instructions that, when executed by processor 102, can facilitate performance of operations. Processor 102 can be a hardware processor having structural elements known to exist in connection with processing units or circuits, with various operations of processor 102 being represented by functional elements shown in the drawings herein that can require special-purpose instructions, for example stored in memory 104 and/or PII detection/protection 106 component or circuit. Along with these special-purpose instructions, processor 202 and/or system 100 can be a special-purpose device or system. Further examples of the memory 104 and processor 102 can be found with reference to FIG. 13. It is to be appreciated that system 100 or computer 1312 can represent a server device or a client device and can be used in connection with implementing one or more of the systems, devices, or components shown and described in connection with FIG. 1 and other figures disclosed herein. In some embodiments, system 100, and other systems, devices, or components, can be embodied as a non-transitory computer-readable medium having stored there on computer-executable instructions that are executable by the system to cause the system to perform certain operations.

System 100 can receive text data 108. In some embodiments, text data 108 can be generated by extracting text data 108 from file 110 comprising recorded speech or other aspects from which PII can be obtained or presented. As representative examples, file 110 can be an audio file encoded according to an audio format or a video file encoded according to a video format. Text data 108 can represent a transcription of the recorded speech that is presented in response to playing or otherwise executing file 110. In response to examining text data 108, system 100 can determine that text data 108 comprises PII 114, which is illustrated reference numeral 112.

As illustrated at reference numeral 116, in response to PII 114 being detected and/or identified in text data 108, system 100 can generate time map 118. Time map 118 can identify one or more time segments 120 of file 110 that correspond to a presentation of PII 114. For instance, in this example, presentation timeline 122 (e.g., when playing or executing file 110) is about two minutes and five seconds in length. Upon examination, system 100 has identified from text data 108, two portions that include PII 114. Time map 118 can map those two portions of text data 108 to presentation timeline 122 of file 110, which is illustrated here as PII 114₁ and 114₂.

For example, suppose at about 25 seconds into a customer care call, the customer states his or her account number, which is mapped to 0:25:00 to 0:35:00 of presentation timeline 122 and illustrated at time segment 120₁. Subsequently, from about 1:10:00 to about 1:20:00 the customer mentions a residential address, which is illustrated by time segment 120₂.

Based on time map 118, which can map identified instances of PII 114 found in text data 108 to corresponding time segments 120 of presentation timeline 122 of file 110, system 200 can perform an encryption procedure, as illustrated at reference numeral 126. For example, system 200 can encrypt portion 124 of file 110 that corresponds or matches time segments 120. Because portions 124 of file 110 are encrypted (e.g., those portions determined to contain PII 114) those portions are not readily accessible without an authorized mechanism for decryption, and thus can satisfy privacy law constraints.

On the other hand, other parts of file 110 are not encrypted and these other parts tend to be more important for quality and training purposes. Hence, despite satisfying the privacy law constraints by protecting PII 114, much of file 110 can remain unencrypted and still useful for its original purpose and reason for storing in the first place. After encryption, presentation timeline 122 can be truncated (or blurred in the context of video). In that case, review of file 110 can be similar to the original recording, but at time segments 120 where PII 114 is divulged, such can be skipped or blurred as, that encoded information is encrypted and inaccessible by ordinary means. It is further envisioned that rather than truncating or blurring, anonymized data can be inserted or linked, so as to maintain a natural flow of presentation timeline 122. For example, the actual address stated in the customer's voice at time segment 120₂ (which is now encrypted) can be substituted with a digitized voice that indicates a generic address (e.g., 123 Mockingbird Lane), with leftover time truncated but in this case without an abrupt interruption to the flow of presentation timeline 122.

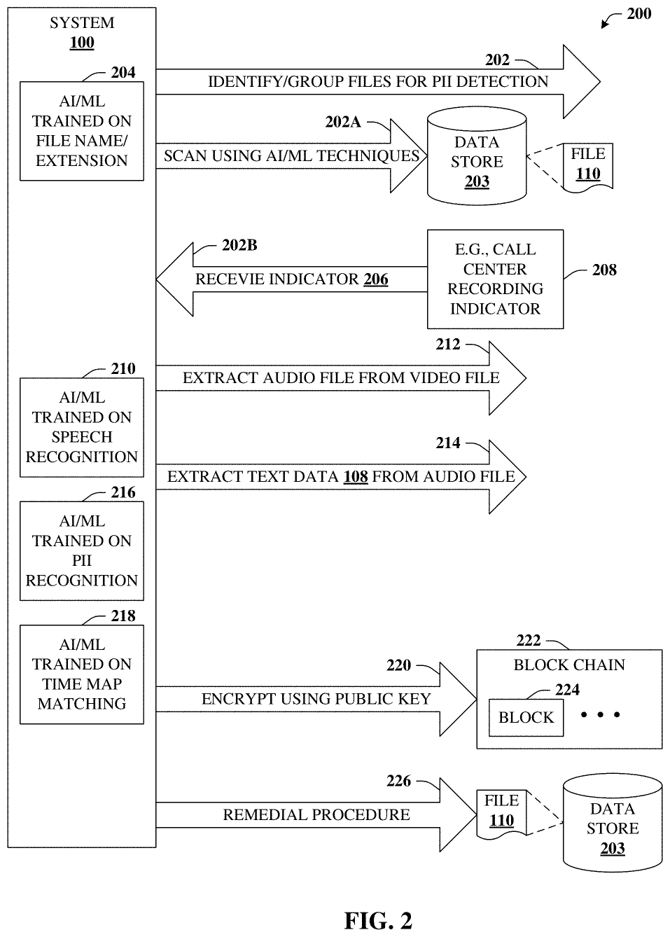

Referring now to FIG. 2, a schematic block diagram 200 is depicted illustrating additional aspects or elements of system 100 in connection with identification and protection of PII in accordance with certain embodiments of this disclosure.

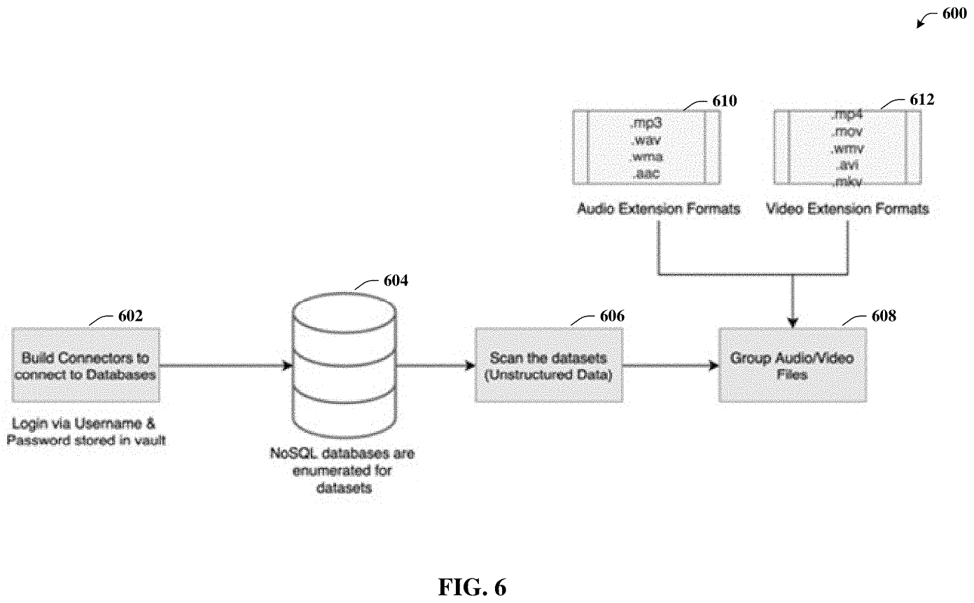

As illustrated at reference numeral 202, system 100 can identify and/or group files (e.g., file 110) for PII detection (e.g., scan to identify and/or group files that are to be examined). In that regard, system 100 can identify AV files such as audio files or video files. Such can be efficiently accomplished by an artificial intelligence (AI) model and/or machine learning (ML) model 204 that is trained to identify files (e.g., file 110) based on a name of the file or an extension of the file (e.g., .mp3, .mp4, . . . ), several additional examples of which are provided in connection with FIG. 6.

It is appreciated that there are different potential approaches to identifying 202 potential files. For instance, system 100 can scan company data stores 203 using ML model 204, which is illustrated at reference numeral 202A. Data store 203 can be an unstructured data store with many AV files. In some embodiments, data store 203 can be a structured data store, with BLOB-type entries, which can be scanned. As another approach, system 100 can identify 202 in response to receiving an indicator 206. Indicator 206 can be, e.g., an indicator that a file is being generated in response to a recorded event (e.g., call center 208 customer support call) in which presentation of PII 114 is determined to be likely, which can occur in response to a probability score being above a defined threshold. Hence, it is appreciated that system 100 can operate to identify and protect PII 114 on existing data stores 203 as well as activate in real-time as new files are being generated in response to current calls. In other words, the techniques disclosed herein can be used to transform existing data stores that do not satisfy privacy law requirements into data stores that that attempt to be in accord (e.g., approach 202A) and thereafter to ensure that all data written to the data store (e.g., approach 202B) is also in accord with privacy requirements or guidelines.

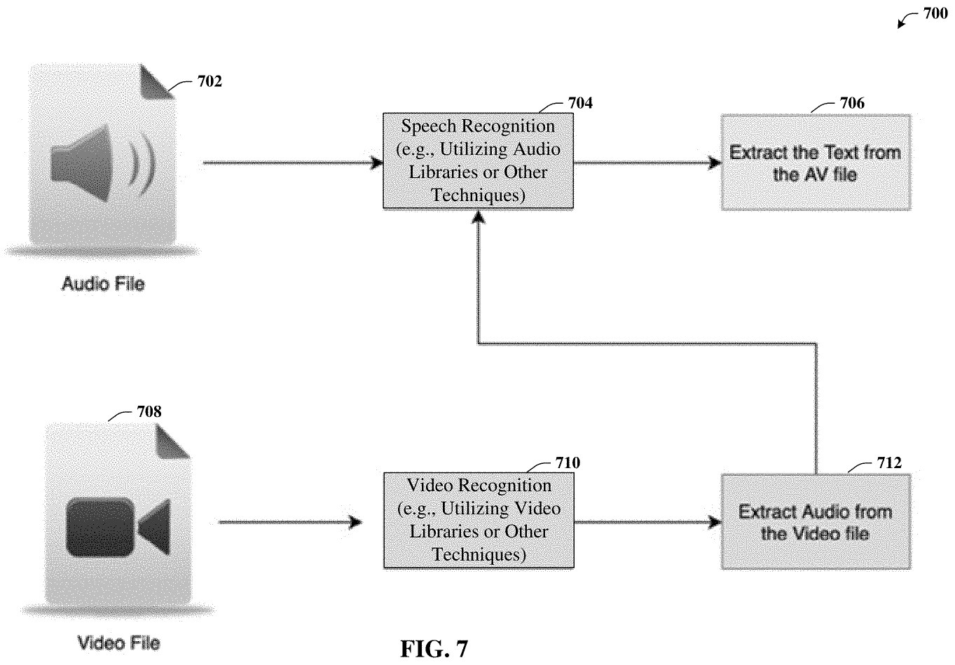

In some embodiments, once relevant files (e.g., AV files) are identified 202 and/or grouped, text data 108 can be extracted. To facilitate such, in some embodiments, system 100 can comprise ML model 210. ML model 210 can be trained according to speech recognition techniques. An example of such that relies on suitable libraries is illustrated at FIG. 7. In some embodiments, in the case of a video file, audio portions can be extracted first, as illustrated at reference numeral 212. In that case, or in the case where file 110 is an audio file, text data 108 can be extracted from the audio file, which is illustrated at reference numeral 214. As a result, text data 108 can represent transcription of recorded speech presented by file 110. Form this text-based transcription PII can be more readily identified, as was introduced above in connection with FIG. 1.

In some embodiments, system 100 can comprise ML model 216, e.g., to facilitate PII detection 112 (of FIG. 1). ML model 216 can be trained to identify a presentation of PII 114. When using text data 108 as input, such can represent personal information such as name, address, mother's maiden name and so forth. Furthermore, in some embodiments, ML model 216 can be applied to file 110 and be trained to identify PII 114 in the form of biometrics such as face, voice, or certain images or sounds.

As indicated above, system 100 can generate time map 118 that identifies time segment 120 of file 110 that corresponds to disclosure of PII 114. In some embodiments, system 100 can further include ML model 218. ML model 218 can be trained to precisely match PII 114, found in text data 108, to corresponding portions of presentation timeline 122 of file 110. Thus, time map 118 can be utilized to encrypt the proper portions 124 of file 110, as indicated above in connection with FIG. 1. Hence, once text data 108 is extracted from file 110, that textual information can be synchronized with corresponding audio presentation of PII 114 (e.g., time segments 120) such that the precise timeframe and transcription are mapped.

In some embodiments, as illustrated here at reference numeral 220, said encryption can encrypt portions 124 with a public key that is associated with an entity to which PII 114 applies (e.g., the customer on the customer call). As a result of encryption 220, portions 124 can become inaccessible without an associated private key of the entity. Thus, the entity may choose to allow access for purposes of quality and training, but may also refuse or even discard the private key such that PII 114 cannot be accessed for any purpose. It is further appreciated that encryption 220 (or encryption 126) can further encrypt text data 108 and other relevant information, or, after encryption 220, 126, such can be deleted.

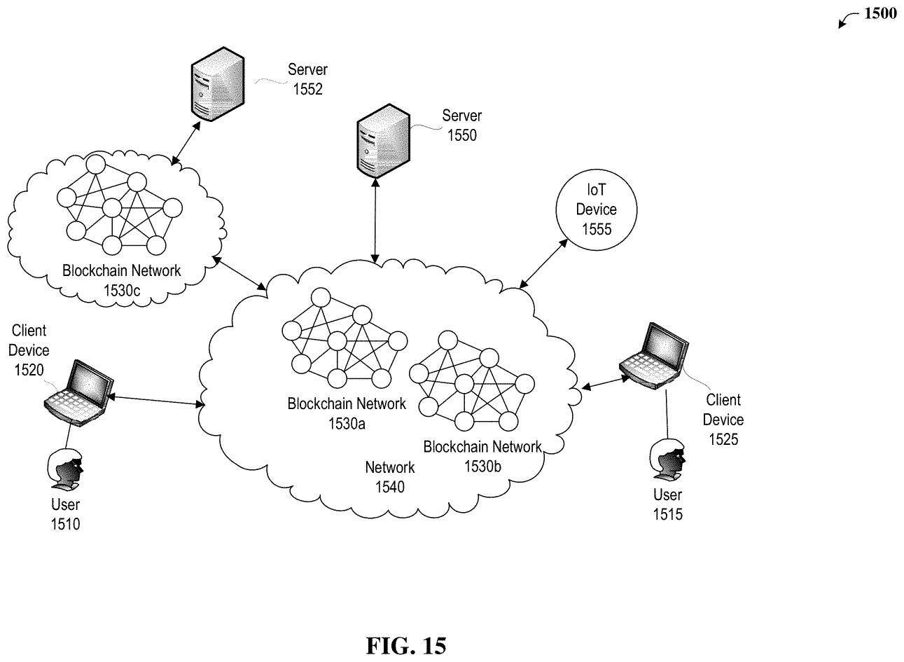

In some embodiments, the encrypting of portion 124 of file 110 can result in an encrypted portion of file 110. This encrypted portion (along with encrypted text data 108 and other relevant encrypted information) can be stored to a block 224 of a blockchain 222. Addition detail relating to blockchain environment and function is provided beginning at FIG. 15.

In some embodiments, system 100 can further perform a remedial procedure 226. Remedial procedure 226 can update a presentation of file 110 in response to portion 124 being the encrypted portion and thus inaccessible due to encryption. Remedial procedure 226 can be performed based on a format associated with file 110. For example, if file 110 is an audio file, remedial procedure 226 can truncate the audio presentation, effectively skipping over portion(s) 124. In other embodiments, relevant but anonymized and/or synthesized audio can be inserted or linked to replace portions 124. In the case of video formats, the same can be done, but in addition, facial features can be blurred, for instance, to ensure lip reading techniques or the like are not available during a presentation. As with the encryption procedures, remedial procedure 226 can rely on time map 118. Thereafter, file 110, with all the encrypted and remedial updates can be written back to data store 203.

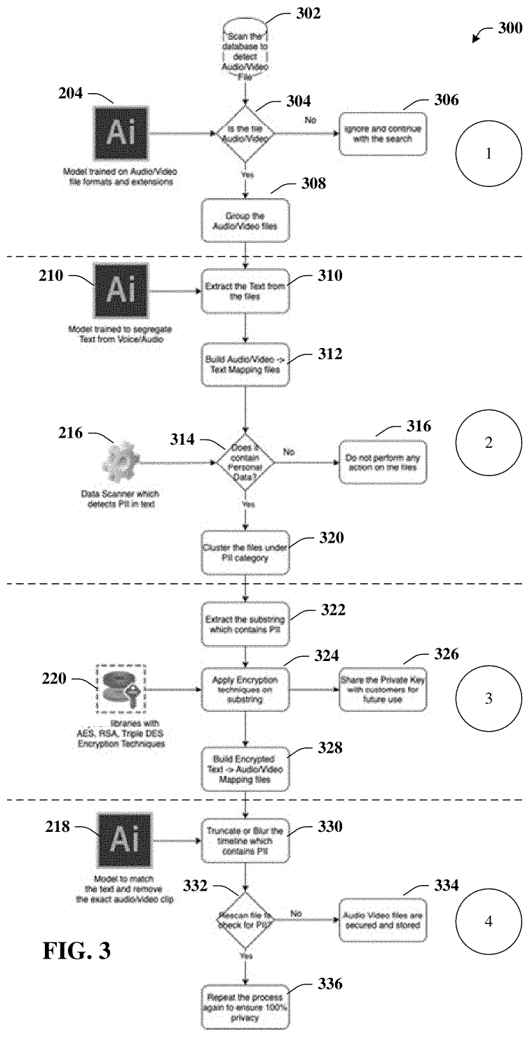

To provide addition context and detail in connection with the disclosed subject matter, FIG. 3 depicts an example schematic flow diagram 300 illustrating example techniques of identification and protection of PII in accordance with certain embodiments of this disclosure. Diagram 300 is divided into four distinct sections that are detailed sequentially herein. In this context, section 1 relates generally to scanning and other related techniques, section two relates generally to mapping and other related techniques, section three relates to masking and other related techniques, and section four relates to merging and other related techniques.

At reference numeral 302, a company's data store (e.g., data store 203) can be scanned to detect A/V files (e.g., file 110). Such can be performed by ML model 204, as detailed in connection with FIG. 2 that can be trained on A/V file formats and extensions. For example, at reference numeral 304, ML model 204 can determine whether the file being appraised is an A/V file. If not, in some embodiments, that file can be ignored and the next file examined, as indicated at reference numeral 306. Otherwise, as indicated at reference numeral 308, the file can be grouped or flagged for examination that occurs in section 2.

By scanning the entirety of data store 203 to identify A/V files, the scanner can make use of the name of the file as well as the file extension to group the files. The type of data store 203 can be taken into consideration. For example, if data store 203 is structured, it can be more efficient to scan only columns with binary large object (BLOB) type indicators need be scanned. If data store 203 is unstructured on the other hand, the entirety of the data store can be scanned.

In section 2, at reference numeral 310, ML model 210 can extract text from the files that were grouped at reference numeral 308. At reference numeral 312, A/V to text mapping can be generated, e.g., as detailed in connection with time map 118. By using ML model 216 for example, at reference numeral 314, it can be determined whether text data 108 contains PII 114. If not, then at reference numeral 316, no further action need be taken. Otherwise, at reference numeral 320 those files that do contain PII 114 can be clustered under an appropriate designation. Mapping the text to the A/V file can be accomplished by extracting the text from the files and forming an A/V-to-time map. This map can subsequently be used for both the masking (section three) and merging (section four) stages. Further, the personal data scanner can again be executed on the extracted text to filter out those files containing PII 114.

In section 3, at reference numeral 322, substrings containing PII 114 can be extracted. At reference numeral 324, encryption techniques can be applied to those substrings. Such can be in accordance with encryption 220 detailed in connection with FIG. 2, or according to other techniques. At reference numeral 326, the associated private key can be shared or surfaced for the customer's future use. At reference numeral 328, encrypted text-to-A/V mapping files can be generated.

It is appreciated that indexing of the files can be done along with the extracted text. For instance, the timeline containing PII 114 can be marked (e.g., 00:10:00 to 00:10:30 contains a name of the customer, 00:23:35 to 00:24:20 contains an address, and so on) and a synchronization map can be generated.

In section 4, at reference numeral 330 the timeline containing PII 114 can be truncated or blurred or otherwise updated according to, e.g., remedial procedure 226. Such can leverage ML model 218 as detailed in connection with FIG. 2. At reference numeral 332, it can be determined whether or not to rescan to check for other PII 114. If not, the appropriate files can be secured and store at reference numeral 334. Otherwise, at reference numeral 336, the flow can proceed back to section 1 to repeat scanning and subsequent activities.

It is appreciated that additional audio analysis can be performed to encrypt only the audio capsules containing PII 114, which can be handled by ML model 218. An associated private key can be provided to the customer or otherwise identified by a host application. If decryption is requested, the customer can be notified of the request.

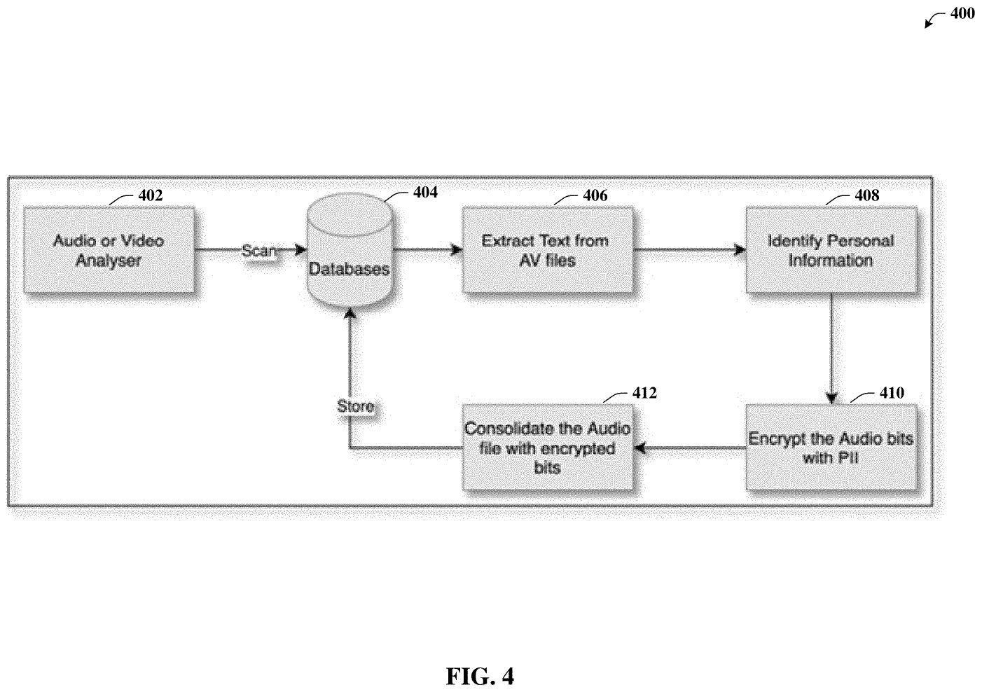

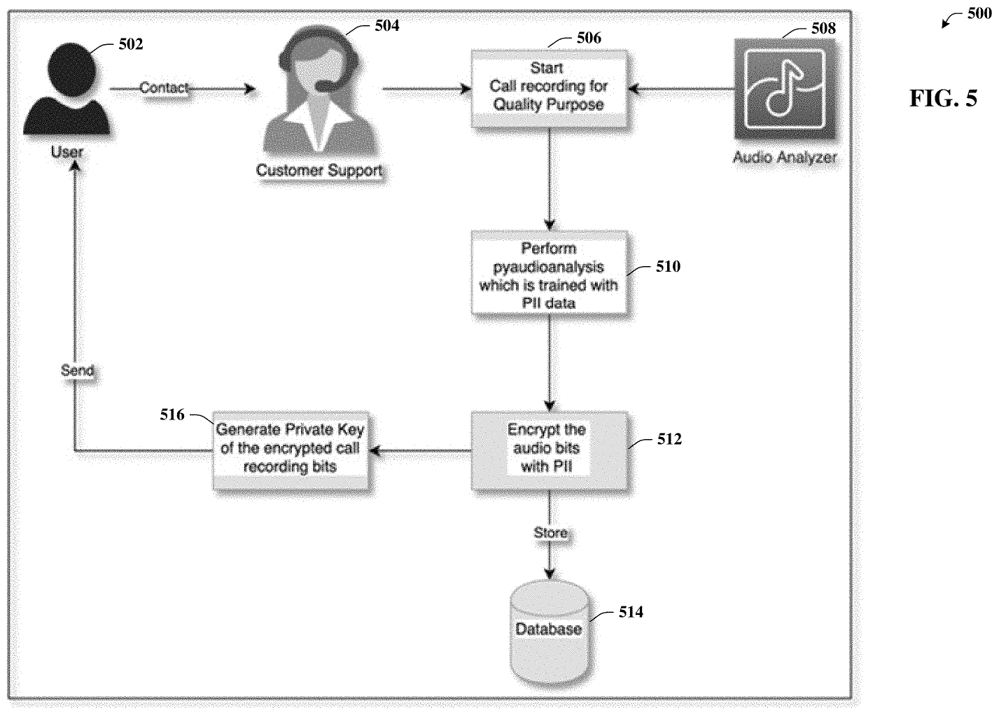

FIGS. 4-6 provide additional detail in connection with grouping or scanning, which was reviewed in connection with section 1 of flow diagram 300. In that regard, FIG. 4 illustrates an example schematic flow diagram 400 illustrating a data store analyzer applied to existing data in accordance with certain embodiments of this disclosure. FIG. 5 illustrates an example schematic flow diagram 500 illustrating an audio analyzer applied on-the-fly to recorded interactions in accordance with certain embodiments of this disclosure. FIG. 6 illustrates an example schematic flow diagram 600 illustrating additional aspects or elements relating to scanning and interfacing data stores in accordance with certain embodiments of this disclosure.

Regarding FIG. 4, at reference numeral 402, an A/V analyzer can scan one or more data stores and/or databases 404. At reference numeral 406, text can be extracted from the A/V files. At reference numeral 408, PII 114 can be identified. At reference numeral 410, A/V portions with PII 114 (e.g., portion 124) can be encrypted. At reference numeral 412, the A/V files with encrypted portions can be consolidated and stored to the data store 404.

It is appreciated that such can effectuate a scanning procedure of all data stores to identify the A/V files across structured and unstructured data stores. The model used (e.g., ML model 204) can parse the files sequentially and group those files based on file name, which can eventually form a cluster of only A/V files. Such can leverage any suitable technology. As one example, ML model 204 can be constructed using suitable in-built libraries (e.g., libraries for audio analysis, libraries for video analysis, and so on).

Regarding FIG. 5, a customer 502 (or other suitable entity) can contact (or be contacted by) company personnel such as a customer support employee. Typically, customer 502 is informed that the interaction is being recorded, e.g., for training or evaluation purposes. At reference numeral 506, the recording is started. Such can trigger audio analyzer 508, which can, at reference numeral 510, perform audio analysis that is trained on PII 114 data. At reference numeral 512, the audio portions (e.g., portions 124) can be encrypted and, thereafter, stored to data store 514, which can be substantially similar to data store 203 detailed supra. At reference numeral 516, a private key can be provided to customer 502 and/or otherwise indicated or identified. Thus, the (partially) encrypted file (e.g., file 110) can remain largely intact such that file 110 can be replayed (e.g., for quality or training purposes), be the media decoder will not be capable of playing those portions that are encrypted, and therefore PII 114 will be protected. In order to replay file 110 as originally recorded, the private key can be requested from customer 502, which customer 502 may or may not choose to provide.

Regarding FIG. 6, at reference numeral 602, suitable connectors can be built or selected to connect to data store 604. Such can include, for example, interface information as well as login parameters such as username and password stored in a vault. It is appreciated that NoSQL data stores can be enumerated for datasets. At reference numeral 606, the datasets (e.g., unstructured data) can be scanned. At reference numeral 608, A/V files can be grouped according to file name or file extensions. A non-limiting list of example audio format extensions is given at reference numeral 610 and a non-limiting list of example video format extensions is given at reference numeral 612. It is appreciated that other suitable extensions can be identified and other suitable techniques can be used to identify the A/V files outside of name or file extension techniques.

Turning now to FIG. 7, schematic flow diagram 700 is depicted. Flow diagram 700 illustrates additional aspects or elements in connection with extracting text data from A/V files in accordance with certain embodiments of this disclosure. In the context of flow diagram 300, flow diagram 700 relates to section 2. In this example, depending on the format of file 110, processing can differ. For example, if file 110 is a video file 708, then such can be processed differently (and/or have additional steps) than if file 110 is an audio file 702.

For instance, at reference numeral 704 speech recognition techniques can be applied to audio file 702. As illustrated, one example technology relies on a model built on libraries or based on other speech recognition techniques. A result of the processing is to extract text from the A/V file, as depicted at reference numeral 706. In the case of video file 708, another model, potentially built on video libraries or other video recognition techniques, can be utilized, as indicated at reference numeral 710. This other model can be utilized to extract audio from video file 708. This extracted audio can then be fed into the speech recognition model just as described in connection with audio file 702.

Once this mapping of the text to A/V files is accomplished, an associated A/V-to-text map (e.g., time map 118) can be constructed that maps PII 114 found in the text to corresponding portions 124 of file 110. As noted, this audio-to-time map can be used to precisely match where in file 110 the PII 114 exists, which can eventually also be leveraged in the masking (section 3) and merging (section 4) phases.

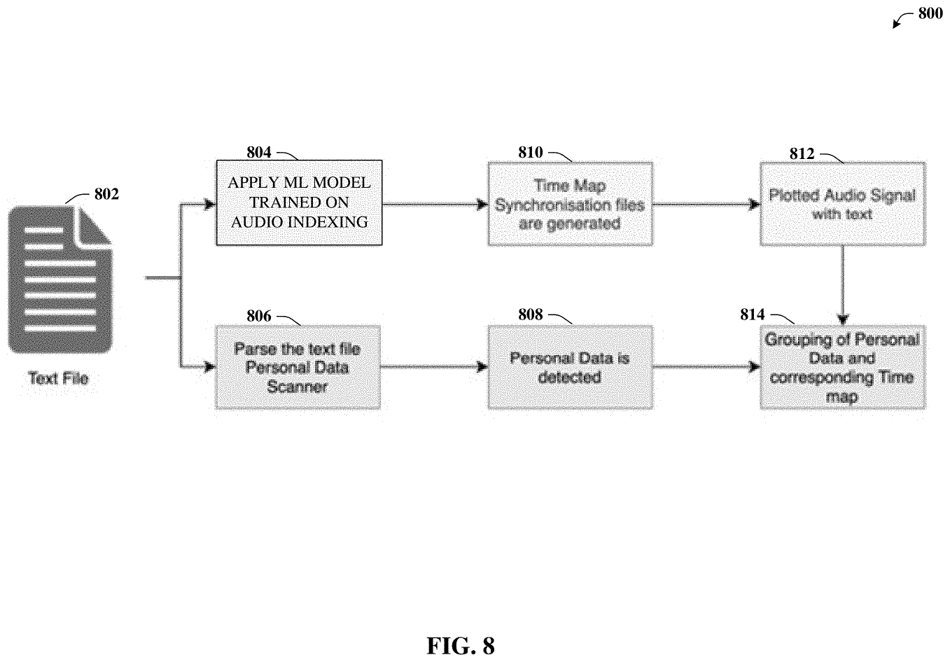

With reference now to FIG. 8, schematic flow diagram 800 is depicted. Flow diagram 800 illustrates an example PII scanner and audio text plot in accordance with certain embodiments of this disclosure. For example, text data 108 can be extracted and the portions containing PII 114 can be masked from the A/V files using public key encryption. If the customer wants to access the files, a private key can be used to decrypt. The substring of actual text which contains PII 114 can be encrypted, hence securing the data as per regulatory requirements. It is appreciated that any suitable type of encryption can be used. As one example, asymmetric encryption techniques can be used to mask the data using a public-private key pair. Encryption algorithms such as advanced encryption standard (AES), RSA (also known as Rivest-Shamir-Adleman) encryption, triple data encryption standard (DES) can be utilized and can be selected based on the needs of the client or other implementation details.

In more detail, text file 802 can be generated representing a transcription of recorded speech of an A/V file, which can be representative of text data 108. At reference numeral 804 an ML model (e.g., ML model 218) trained on audio indexing can process text file 802. Meanwhile, at reference numeral 806, text file 802 can be parsed with a PII scanner (e.g., ML model 216) and at reference numeral 808, PII 114 is detected within text file 802.

At reference numeral 810, flowing from reference numeral 804, time map (e.g., time map 118) synchronization files can be generated and at reference numeral 812 can be plotted over the audio signal to identify the precise mapping. At reference numeral 814, PII and corresponding time map(s) can be grouped together.

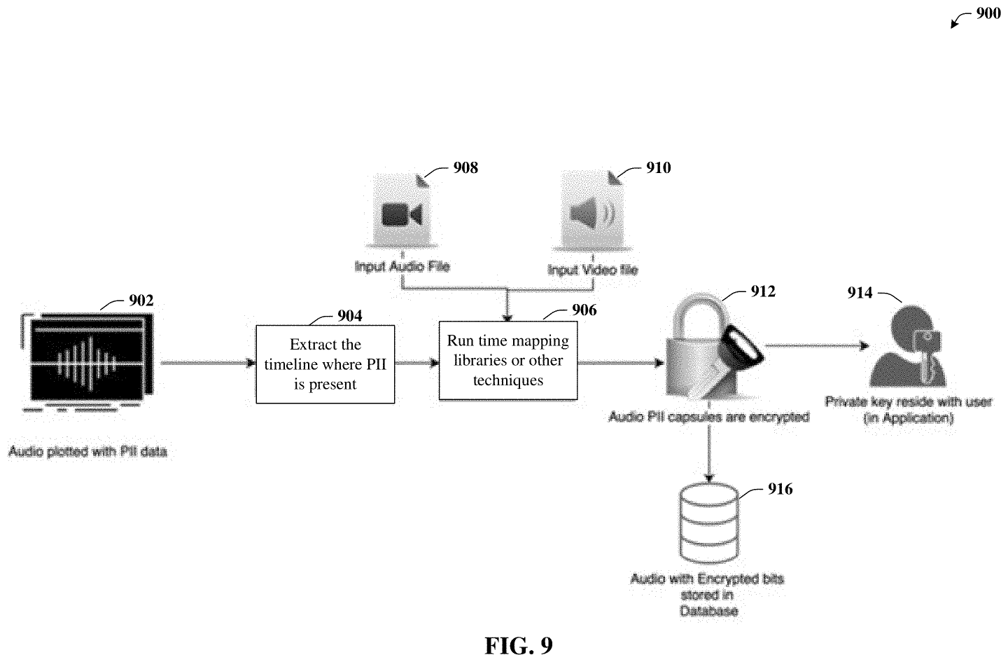

Referring to FIG. 9, schematic flow diagram 900 is depicted. Flow diagram 900 illustrates additional aspects or elements in connection with masking the PII in accordance with certain embodiments of this disclosure. With reference to audio plot 902 that is plotted with PII 114 data, at reference numeral 904, the timeline of the audio where PII 114 is present can be extracted. At reference numeral 906, input can be received in the form of an A/V file (e.g., file 110) such as audio file 908 or video file 910. ML model 218 can be implemented to get the precise location of PII within the A/V file. As one example, such can use libraries or other techniques to get the exact audio segments mapped to text containing PII 114.

At reference numeral 912, audio capsules containing PII 114 can be encrypted and the private key can reside with customer 914. Additionally, the A/V file with encrypted portions can be stored to data store 916.

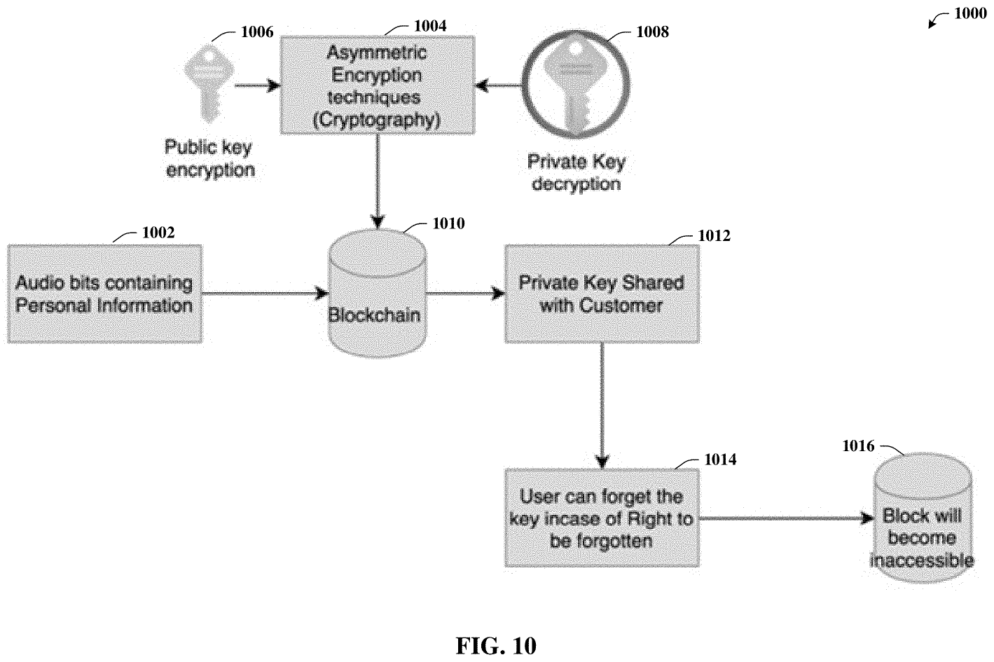

Turning now to FIG. 10, schematic flow diagram 1000 is depicted. Flow diagram 1000 illustrates additional aspects or elements in connection with encrypting information in accordance with certain embodiments of this disclosure. As previously noted, certain portions (e.g., portion(s) 124) of an A/V file can be identified to contain PII 114, which is indicated at reference numeral 1002. These portions can be encrypted according to suitable encryption techniques such as asymmetric encryption techniques 1004. Such encryption can utilize a key-pair, namely public key 1006 and private key 1008.

In some embodiments, following encryption, the encrypted portions can be placed on a block of blockchain 1010 with private key 1008 residing with the customer, as illustrated by reference numeral 1012. If the customer so desires, he or she can forget or discard private key 1008, as illustrated at reference numeral 1014. In that case, the corresponding block of blockchain 1010 will become inaccessible, as indicated at reference numeral 1016. In some embodiments, the particular block of blockchain 1010 can be selected based on a type of PII 114 or other information that is encrypted. For example, general PII 114 information can be stored on a first block of blockchain 1010, card-related information (PCI) can be stored to a second block of blockchain 1010, personal health information (PHI) can be stored on a third block of blockchain 1010, and so on. Hence, in those embodiments, ML model 216 can be configured to determine a type of PII 114 that is detected and, based on that type, determine which block of blockchain 1010 in which to store the encrypted information.

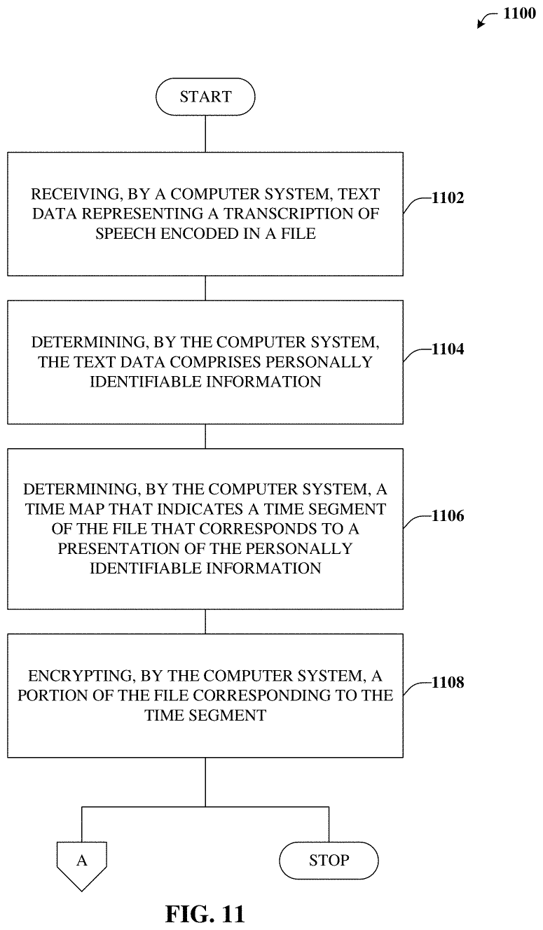

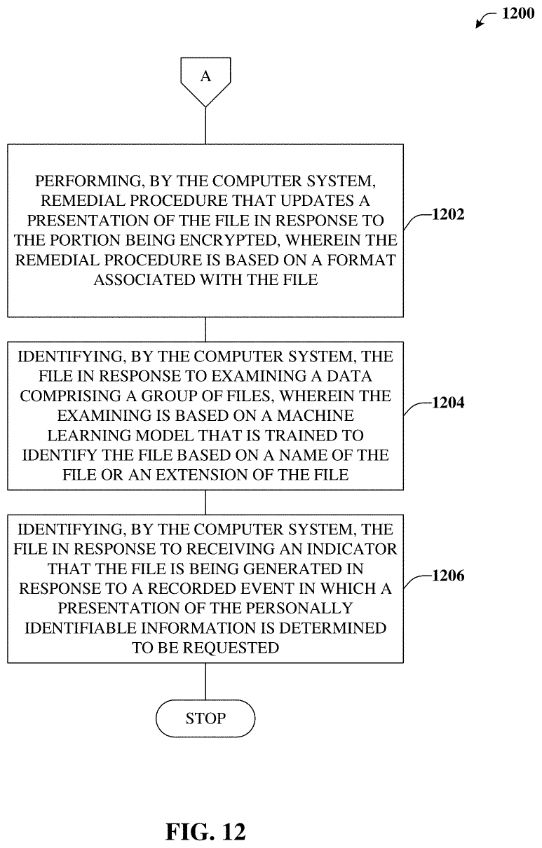

FIGS. 11 and 12 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 11, there is illustrated a methodology 1100 for facilitating identification and protection of PII in accordance with certain embodiments of this disclosure. For example, at reference numeral 1102, a computer system operatively coupled to a processor can receive text data extracted from a file comprising encoded speech. The text data can represent a transcription of the encoded speech.

At reference numeral 1104, the computer system can determine the text data comprises personally identifiable information or PII. At reference numeral 1106, the computer system can determine or construct a time map. This time map can indicate a time segment of the file that corresponds to a presentation of the personally identifiable information. At reference numeral 1108, the computer system can encrypt a portion of the file corresponding to the time segment, resulting in an encrypted portion that contains the PII in encrypted form. Method 1100 can end or proceed to insert A, which is further detailed at FIG. 12.

Turning now to FIG. 12, there illustrated is a methodology 1200 for providing additional aspect or elements in connection with facilitating identification and protection of PII in accordance with certain embodiments of this disclosure. At reference numeral 1202, the computer system can perform a remedial procedure. The remedial procedure can update a presentation of the file in response to the portion being encrypted. In some embodiments, the remedial procedure can be based on a format associated with the file. For example, audio files can be truncated to skip over the PII portions, while video files can be truncated and blurred.

At reference numeral 1204, the computer system can identify the file in response to examining a data comprising a group of files. This examining can be based on a machine learning model that is trained to identify the file based on a name of the file or an extension of the file.

At reference numeral 1206, the computer system can identify the file in response to receiving an indicator that the file is being generated in response to a recorded event in which a presentation of the personally identifiable information is determined to be requested.

### Example Computing Environments

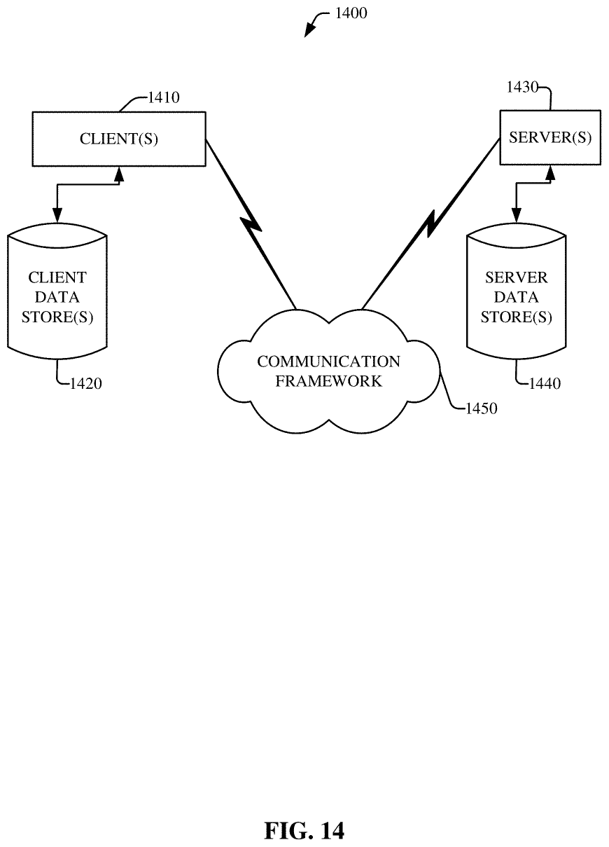

In order to provide a context for the various aspects of the disclosed subject matter, FIGS. 13 and 14 as well as the following discussion are intended to provide a brief, general description of a suitable environment in which the various aspects of the disclosed subject matter may be implemented.

With reference to FIG. 13, a suitable environment 1300 for implementing various aspects of this disclosure includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1312 also includes removable/non-removable, volatile/nonvolatile computer storage media. FIG. 13 illustrates, for example, disk storage 1324. Disk storage 1324 includes, but is not limited to, devices like a magnetic disk drive, floppy disk drive, tape drive, Jaz drive, Zip drive, LS-100 drive, flash memory card, or memory stick. The disk storage 1324 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used, such as interface 1326.

FIG. 13 also depicts software that acts as an intermediary between users and the basic computer resources described in the suitable operating environment 1300. Such software includes, for example, an operating system 1328. Operating system 1328, which can be stored on disk storage 1324, acts to control and allocate resources of the computer system 1312. System applications 1330 take advantage of the management of resources by operating system 1328 through program modules 1332 and program data 1334, e.g., stored either in system memory 1316 or on disk storage 1324. It is to be appreciated that this disclosure can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

FIG. 14 is a schematic block diagram of a sample-computing environment 1400 with which the subject matter of this disclosure can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing this disclosure, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1420 that can be employed to store information local to the client(s) 1410. Similarly, the server(s) 1430 are operatively connected to one or more server data store(s) 1440 that can be employed to store information local to the servers 1430.

### Example Blockchain Architecture

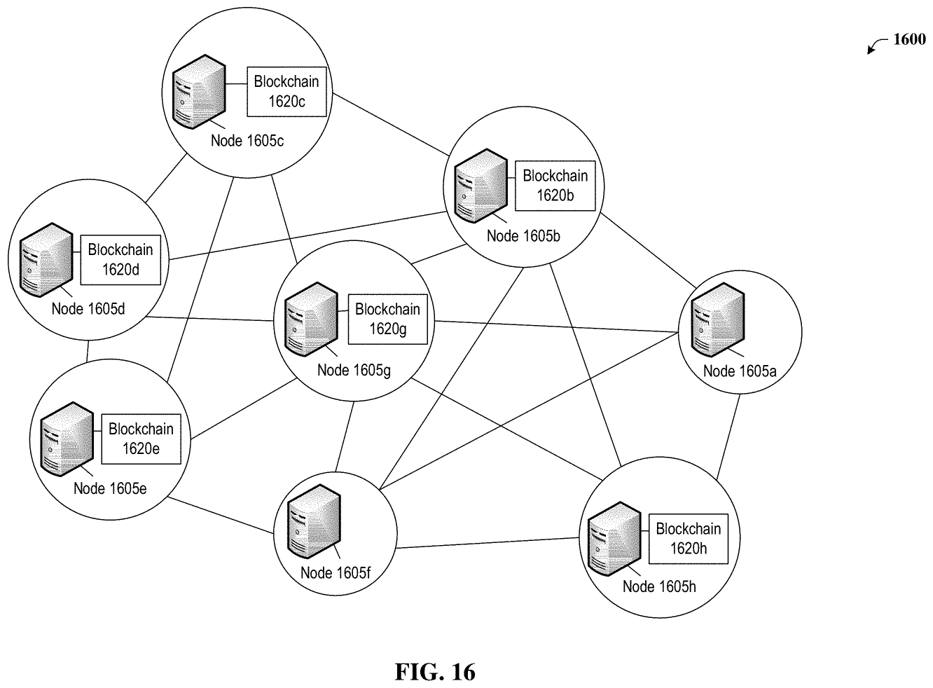

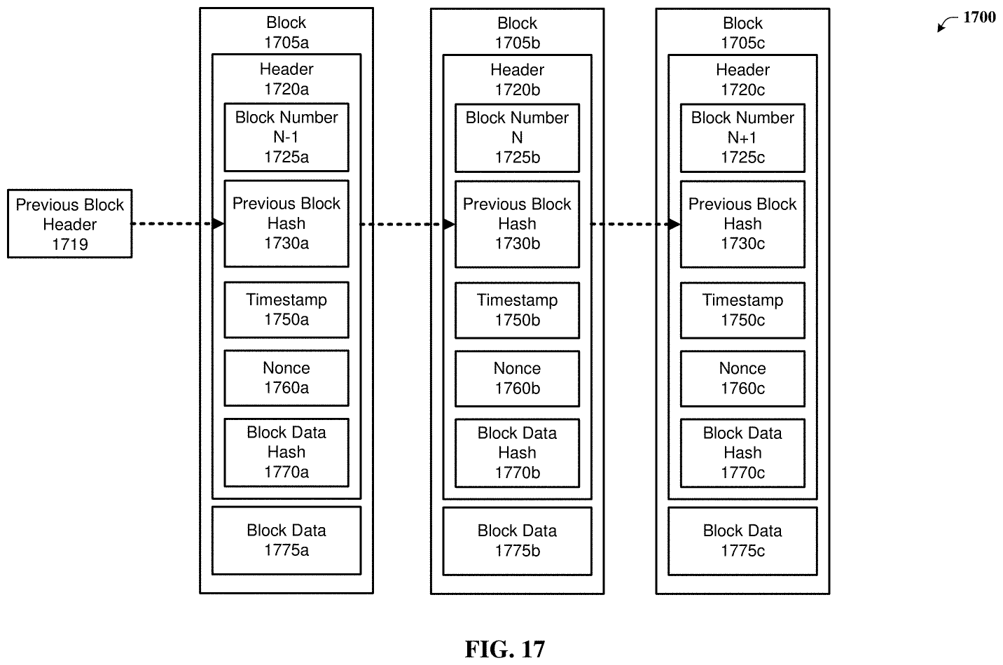

As discussed above, the distributed ledger in a blockchain framework is stored, maintained, and updated in a peer-to-peer network. In one example the distributed ledger maintains a number of blockchain transactions. FIG. 15 shows an example system 1500 for facilitating a blockchain transaction. The system 1500 includes a first client device 1520, a second client device 1525, a first server 1550, and an Internet of Things (IoT) device 1555 interconnected via a network 1540. The first client device 1520, the second client device 1525, the first server 1550 may be a computing device 1905 described in more detail with reference to FIG. 19. The IoT device 1555 may comprise any of a variety of devices including vehicles, home appliances, embedded electronics, software, sensors, actuators, thermostats, light bulbs, door locks, refrigerators, RFID implants, RFID tags, pacemakers, wearable devices, smart home devices, cameras, trackers, pumps, POS devices, and stationary and mobile communication devices along with connectivity hardware configured to connect and exchange data. The network 1540 may be any of a variety of available networks, such as the Internet, and represents a worldwide collection of networks and gateways to support communications between devices connected to the network 1540. The system 1500 may also comprise one or more distributed or peer-to-peer (P2P) networks, such as a first, second, and third blockchain network 1530a-c (generally referred to as blockchain networks 1530). As shown in FIG. 15, the network 1540 may comprise the first and second blockchain networks 1530a and 1530b. The third blockchain network 1530c may be associated with a private blockchain as described below with reference to FIG. 16, and is thus, shown separately from the first and second blockchain networks 1530a and 1530b. Each blockchain network 1530 may comprise a plurality of interconnected devices (or nodes) as described in more detail with reference to FIG. 16. As discussed above, a ledger, or blockchain, is a distributed database for maintaining a growing list of records comprising any type of information. A blockchain, as described in more detail with reference to FIG. 17, may be stored at least at multiple nodes (or devices) of the one or more blockchain networks 1530.

In one example, a blockchain based transaction may generally involve a transfer of data or value between entities, such as the first user 1510 of the first client device 1520 and the second user 1515 of the second client device 1525 in FIG. 15. The server 1550 may include one or more applications, for example, a transaction application configured to facilitate the transaction between the entities by utilizing a blockchain associated with one of the blockchain networks 1530. As an example, the first user 1510 may request or initiate a transaction with the second user 1515 via a user application executing on the first client device 1520. The transaction may be related to a transfer of value or data from the first user 1510 to the second user 1515. The first client device 1520 may send a request of the transaction to the server 1550. The server 1550 may send the requested transaction to one of the blockchain networks 1530 to be validated and approved as discussed below.

### Example Blockchain Network

FIG. 16 shows an example blockchain network 1600 comprising a plurality of interconnected nodes or devices 1605a-h (generally referred to as nodes 1605). Each of the nodes 1605 may comprise a computing device 1905 described in more detail with reference to FIG. 19. Although FIG. 16 shows a single device 1605, each of the nodes 1605 may comprise a plurality of devices (e.g., a pool). The blockchain network 1600 may be associated with a blockchain 1620. Some or all of the nodes 1605 may replicate and save an identical copy of the blockchain 1620. For example, FIG. 17 shows that the nodes 1605b-e and 1605g-h store copies of the blockchain 1620. The nodes 1605b-e and 1605g-h may independently update their respective copies of the blockchain 1620 as discussed below.

### Example Blockchain Node Types

Blockchain nodes, for example, the nodes 1605, may be full nodes or lightweight nodes. Full nodes, such as the nodes 1605b-e and 1605g-h, may act as a server in the blockchain network 1600 by storing a copy of the entire blockchain 1620 and ensuring that transactions posted to the blockchain 1620 are valid. The full nodes 1605b-e and 1605g-h may publish new blocks on the blockchain 1620. Lightweight nodes, such as the nodes 1605a and 1605f, may have fewer computing resources than full nodes. For example, IoT devices often act as lightweight nodes. The lightweight nodes may communicate with other nodes 1605, provide the full nodes 1605b-e and 1605g-h with information, and query the status of a block of the blockchain 1620 stored by the full nodes 1605b-e and 1605g-h. In this example, however, as shown in FIG. 16, the lightweight nodes 1605a and 1605f may not store a copy of the blockchain 1620 and thus, may not publish new blocks on the blockchain 1620.

### Example Blockchain Network Types

The blockchain network 1600 and its associated blockchain 1620 may be public (permissionless), federated or consortium, or private. If the blockchain network 1600 is public, then any entity may read and write to the associated blockchain 1620. However, the blockchain network 1600 and its associated blockchain 1620 may be federated or consortium if controlled by a single entity or organization. Further, any of the nodes 1605 with access to the Internet may be restricted from participating in the verification of transactions on the blockchain 1620. The blockchain network 1600 and its associated blockchain 1620 may be private (permissioned) if access to the blockchain network 1600 and the blockchain 1620 is restricted to specific authorized entities, for example organizations or groups of individuals. Moreover, read permissions for the blockchain 1620 may be public or restricted while write permissions may be restricted to a controlling or authorized entity.

### Example Blockchain

As discussed above, a blockchain 1620 may be associated with a blockchain network 1600. FIG. 17 shows an example blockchain 1700. The blockchain 1700 may comprise a plurality of blocks 1705a, 1705b, and 1705c (generally referred to as blocks 1705). The blockchain 1700 comprises a first block (not shown), sometimes referred to as the genesis block. Each of the blocks 1705 may comprise a record of one or a plurality of submitted and validated transactions. The blocks 1705 of the blockchain 1700 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 1700 may be stored locally, in the cloud, on grid, for example by the nodes 1605b-e and 1605g-h, as a file or in a database.

### Example Blocks

Each of the blocks 1705 may comprise one or more data fields. The organization of the blocks 1705 within the blockchain 1700 and the corresponding data fields may be implementation specific. As an example, the blocks 1705 may comprise a respective header 1720a, 1720b, and 1720c (generally referred to as headers 1720) and block data 1775a, 1775b, and 1775c (generally referred to as block data 1775). The headers 1720 may comprise metadata associated with their respective blocks 1705. For example, the headers 1720 may comprise a respective block number 1725a, 1725b, and 1725c. As shown in FIG. 17, the block number 1725a of the block 1705a is N−1, the block number 1725b of the block 1705b is N, and the block number 1725c of the block 1705c is N+1. The headers 1720 of the blocks 1705 may include a data field comprising a block size (not shown).

The blocks 1705 may be linked together and cryptographically secured. For example, the header 1720b of the block N (block 1705b) includes a data field (previous block hash 1730b) comprising a hash representation of the previous block N−1's header 1720a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 1720c of the block N+1 (block 1705c) includes a data field (previous block hash 1730c) comprising a hash representation of block N's (block 1705b) header 1720b.

The headers 1720 of the blocks 1705 may also include data fields comprising a hash representation of the block data, such as the block data hash 1770a-c. The block data hash 1770a-c may be generated, for example, by a Merkle tree and by storing the hash or by using a hash that is based on all of the block data. The headers 1720 of the blocks 1705 may comprise a respective nonce 1760a, 1760b, and 1760c. In some implementations, the value of the nonce 1760a-c is an arbitrary string that is concatenated with (or appended to) the hash of the block. The headers 1720 may comprise other data, such as a difficulty target.

The blocks 1705 may comprise a respective block data 1775a, 1775b, and 1775c (generally referred to as block data 1775). The block data 1775 may comprise a record of validated transactions that have also been integrated into the blockchain 1600 via a consensus model (described below). As discussed above, the block data 1775 may include a variety of different types of data in addition to validated transactions. Block data 1775 may include any data, such as text, audio, video, image, or file, which may be represented digitally and stored electronically.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, and other elements that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a processor; and
a non-transitory computer-readable medium having stored thereon computer-executable instructions that are executable by the system to cause the system to perform operations comprising:
in response to examining text data extracted from a file comprising recorded speech, determining that the text data comprises personally identifiable information;
generating a time map that identifies a time segment of the file that corresponds to a presentation of the personally identifiable information; and
based on the time map, encrypting a portion of the file corresponding to the time segment.

2. The system of claim 1, wherein the operations further comprise identifying the file in response to examining a data store comprising a group of files, wherein the examining is based on a machine learning model that is trained to identify the file based on a name of the file or an extension of the file.

3. The system of claim 1, wherein the operations further comprise identifying the file in response to receiving an indicator that the file is being generated in response to a recorded event in which a presentation of the personally identifiable information is determined to have a probability above a defined threshold.

4. The system of claim 1, wherein the file is one of a group comprising: an audio file encoded according to an audio format and a video file encoded according to a video format.

5. The system of claim 4, wherein the text data is extracted from the audio file based on a machine learning model that is trained according to speech recognition techniques.

6. The system of claim 4, wherein the operations further comprise extracting the audio file from the video file and extracting the text data from the audio file.

7. The system of claim 1, wherein the determining that the text data comprising the personally identifiable information is based on a machine learning model that is trained to identify a presentation of the personally identifiable information.

8. The system of claim 1, wherein the encrypting the portion of the file corresponding to the time segment comprises encrypting the portion with a public key associated with an entity to which the personally identifiable information applies, resulting in the portion being inaccessible without an associate private key of the entity.

9. The system of claim 1, wherein the encrypting the portion of the file corresponding to the time segment further comprises encrypting the text data.

10. The system of claim 1, wherein the encrypting the portion of the file corresponding to the time segment results in an encrypted portion, and wherein the encrypted portion is stored in a block of a blockchain.

11. The system of claim 1, wherein the operations further comprise performing a remedial procedure that updates a presentation of the file in response to the portion being inaccessible due to encryption, wherein the remedial procedure is performed based on a format associated with the file.

12. A computer program product for facilitating increased protection of personally identifiable information, the computer program product comprising a computer-readable medium having program instructions embodied therewith, the program instructions executable by a computer system to cause the computer system to perform operations comprising:
receiving text data extracted from a file comprising encoded speech;
determining the text data comprises personally identifiable information;
determining a time map that indicates a time segment of the file that corresponds to a presentation of the personally identifiable information; and
encrypting a portion of the file corresponding to the time segment.

13. The computer program product of claim 12, wherein the operations further comprise, encrypting the portion with a public key associated with an entity to which the personally identifiable information applies, resulting in the portion being inaccessible without an associate private key of the entity.

14. The computer program product of claim 13, wherein the operations further comprise, providing the entity with access to the private key.

15. The computer program product of claim 12, wherein the encrypting the portion of the file corresponding to the time segment further comprises encrypting the text data.

16. The computer program product of claim 12, wherein the operations further comprise, storing an encrypted portion of the file to a block of a blockchain.

17. A computer-implemented method, comprising:
receiving, by a computer system, text data representing a transcription of speech encoded in a file;
determining, by the computer system, the text data comprises personally identifiable information;
determining, by the computer system, a time map that indicates a time segment of the file that corresponds to a presentation of the personally identifiable information; and
encrypting, by the computer system, a portion of the file corresponding to the time segment.

18. The computer-implemented method of claim 17, further comprising performing, by the computer system, remedial procedure that updates a presentation of the file in response to the portion being encrypted, wherein the remedial procedure is based on a format associated with the file.

19. The computer-implemented method of claim 17, further comprising identifying, by the computer system, the file in response to examining a data comprising a group of files, wherein the examining is based on a machine learning model that is trained to identify the file based on a name of the file or an extension of the file.

20. The computer-implemented method of claim 17, further comprising identifying, by the computer system, the file in response to receiving an indicator that the file is being generated in response to a recorded event in which a presentation of the personally identifiable information is determined to be requested.
